(19) United States
(12) Patent Application Publication
(10) Pub. No.: US 2020/0034779 A1
(43) Pub. Date: Jan. 30, 2020

(54) System And Method for Continued Slot Management For Hub-And-Spoke Networks

(71) Applicant: International Business Machines Corporation, Armonk, NY (US)

(72) Inventors: Oussama Hanguir, New York, NY (US); Chia Yeow Khiang, Singapore (SG); Laura Wynter, Singapore (SG)

(21) Appl. No.: 16/046,371

(22) Filed: Jul. 26, 2018

(51) Int. Cl. G06Q 10/08

(52) U.S. Cl. CPC G06Q 10/083

(57) ABSTRACT

A method includes collecting an arrival time preference from suppliers of a hub-and-spoke network; determining an equilibrium arrival time solution for each of the suppliers; determining, using the equilibrium arrival time solution for each of the suppliers, a set of allocated arrival times at a hub for each of the suppliers; collecting an updated arrival time preference from each of the suppliers; determining, using the updated arrival time preference from each of the suppliers, a subsequent equilibrium arrival time solution for the suppliers; determining, using the subsequent equilibrium arrival time solution for each of the suppliers, a subsequent set of allocated arrival times at the hub for each of the suppliers; scheduling, based on the subsequent set of allocated arrival times, an arrival time solution at the hub for each of the suppliers; and outputting, at the hub, the scheduled arrival time solution for each of the suppliers.

### BACKGROUND

The exemplary embodiments described herein relate generally to logistical aspects of delivery systems and, more specifically, to sequential decision-making operations for the online scheduling of actors in hub-and-spoke delivery networks.

The operations of a hub-and-spoke delivery facility generally involve interactions between a facility operator and multiple actors that serve and are served by the facility. Such operations may occur in the maritime industry, where the facility is a port operator that receives and/or distributes shipping containers and the actors are transportation providers that supply and/or receive the shipping containers. Other industries (for example, parcel delivery, material handling, railroads, airports, and the like) may also operate as hub-and-spoke delivery facilities.

Complexities associated with the operations of these facilities in terms of the logistical dynamics of scheduling and the heterogeneity of the actors in the various decision-making processes may make the development of new operational models a challenge. In particular, at any given time, there are typically more actors that supply to and/or receive from a hub than there are slots available for accommodating the actors. This results in a need to schedule slots for the actors to load and unload cargo or people.

The scheduling is often carried out days or weeks before the actors arrive at the hub. This may result in complicated optimization problems that do not account for real-time actor information (such as satellite position when relying on global positioning satellite (GPS) systems, the state of an actor, or potential delays due to other factors). Scheduling too far in advance of an anticipated delivery or receiving operation also may not account for joint preferences of the actors and the hub. For example, a change in the packaging of a particular type of cargo may require a change to the type of equipment for loading from or unloading to the hub, which may not be known to one of the actors until the actor arrives at the hub.

### BRIEF SUMMARY

In accordance with one aspect, a method comprises collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

In accordance with another aspect, a computer system comprises one or more memories having computer readable code; one or more processors, where the one or more processors, in response to retrieving and executing the computer readable code, cause the computer system to perform the following: collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

In accordance with another aspect, a computer program product comprises a computer readable storage medium having program instructions embodied therewith, the program instructions executable by a computer system to cause the computer system to perform operations comprising collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

### BRIEF DESCRIPTION OF THE SEVERAL VIEWS OF THE DRAWINGS

The foregoing and other aspects of exemplary embodiments are made more evident in the following Detailed Description, when read in conjunction with the attached Drawing Figures, wherein:

FIG. 1 is a schematic representation of relationships between actors and a hub in a hub-and-spoke network;

FIG. 2 is a flow of computations between the actors and the hub of FIG. 1 for a scheduler to provide continual slot management;

FIG. 3 is a flow of one exemplary computational process for the scheduler of FIG. 2;

FIG. 4 is a block diagram of one possible internal configuration of elements of a system using the scheduler; and

FIG. 5 is a graphic illustrating a hub decision making framework as a SSLOATP.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

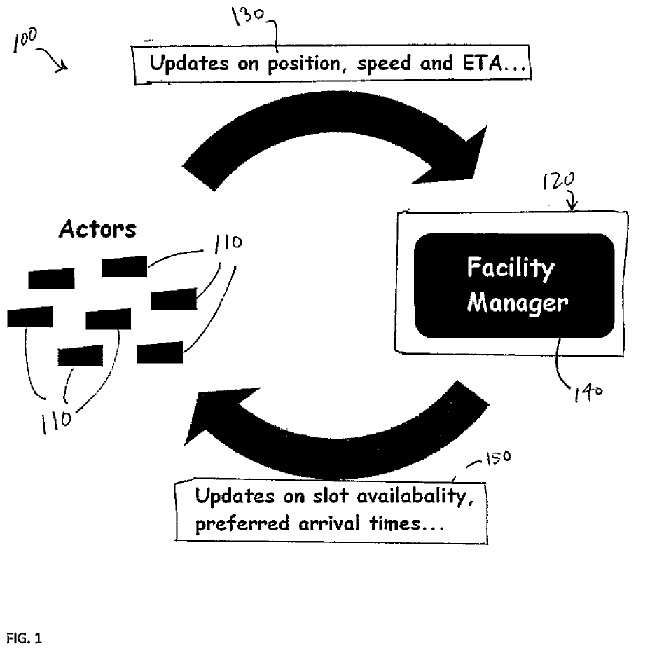

Referring to FIG. 1, one exemplary embodiment of a hub-and-spoke network is shown generally at 100 and is hereinafter referred to as “network 100.” In the network 100, arrival and departure patterns of actors 110 are determined with respect to a hub 120 in order to allocate resources in a sequential manner from both the perspective of the hub 120 and the perspective of each actor 110 (as opposed to only from the perspective of the hub 120). Each actor 110 may supply tangible goods (or people) to the hub 120, or each actor 110 may arrive at the hub 120 as an empty vessel and receive tangible goods (or people) from the hub 120. In some embodiments, however, the actors 110 may both supply and receive from the hub 120.

In order to provide suitably efficient interaction between the hub 120 and the actors 110, logistical elements in the form of arrival and departure patterns of each of the actors 110 may be determined. In determining the arrival patterns, information 130 may be supplied from each of the actors 110 to the hub 120, which may include a facility manager or a hub operator 140. The information 130 may be pertinent to each actor 110 and may comprise, for example, updates on the position of the actor 110, speed of the actor 100, estimated time of arrival, and the like. Information 150 relating to the hub's requirements and objectives may also be supplied from the hub 120 to each of the actors 110, the information comprising, for example, updates on slot availability (such as the locations of various docking ports, preferred arrival times, and the like). Both the information 130 relating to the actors 110 as well as the information 150 relating to the hub's requirements are not limited to the determination of arrival patterns, however, as the information 130, 150 may also pertain to departure patterns. The information 130, 150 may further comprise, for example, time for customs inspections and processing, lengths of time anticipated for loading and/or unloading, holding times required to facilitate the smooth flow of exiting traffic, and the like. Thus, the allocation of resources in a sequential manner is not based solely on the hub's requirements, but also on the requirements of each actor 110, thereby providing for a continual management of the slots of the hub to optimize the system.

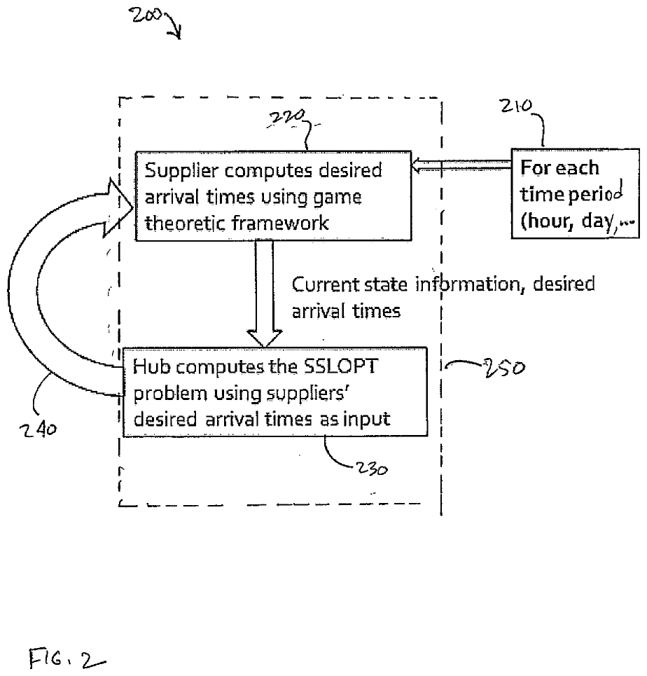

Referring to FIG. 2, one exemplary embodiment of a two-stage sequential decision making process for scheduling the allocation of resources for the network 100 is shown generally at 200 and is hereinafter referred to as “scheduler 200.” In the operation of the scheduler 200, a time period 210 over which the process is carried out for the scheduling is determined. The time period 210 may be, for example, hourly. In particular, the scheduler 200 may be revised and updated on an hourly basis. The scheduler 200 is not limited to being revised and updated hourly, however, as it may be revised and updated every fifteen minutes, or daily, or weekly, depending upon the needs of the hub 120.

The time period 210 may be inputted into the scheduler 200 at a block 220 in which an actor 110 as a supplier (and/or a receiver) computes desired arrival times at the hub 120. The desired arrival times may be computed using a game theoretic framework known as the Nash Equilibrium. The Nash Equilibrium is a solution concept that involves a plurality of players in which each player is assumed to know the equilibrium strategies of the other players, and no player has anything to gain by changing only their own strategy, and each player has chosen a strategy and no player can benefit by changing strategies while the other players keep theirs unchanged. Current state information and the desired arrival times computed from the Nash Equilibrium may then be transferred to a block 230 in which the hub 120 computes a value pertaining to a particular actor 110. Because there may be simultaneous connections to a multitude of actors 110, such a value may be computed for a particular communication protocol on a server port using, for example, an SSLOPT parameter. In such a case, the computation by the hub 120 is carried out using the actor's 110 desired arrival times as input. From this computation in block 230 (computation block 230), arrival times designated by the hub 120 may be returned (as indicated by arrow 240) to the block 220.

A computation segment 250 of the scheduler 200 defines the two-stage sequential decision making process as a continual process in which at initialization (time zero) the actors 110 compute their desired arrival times via the Nash Equilibrium. The desired arrival times computed from the Nash Equilibrium are then updated to the hub 120, which then solves a Single Slot Linear Ordering and Arrival Time Problem (SSLOATP) that takes into account the desired times of the actors 110. Since the desired arrival times of the actors 110 may be incompatible with the hub operator's 140 desired times, the hub operator 140 solves the SSLOATP by relaxing the desired arrival times of the actors 110 into a range of feasible values. The hub operator 140 then solves the SSLOATP and communicates the times of arrival to each of the actors 110. This approach balances the desired arrival times of each actor 110 with the hub operator's 140 schedule. In subsequent time periods, as new information is obtained via satellite data or from other sources, arrival times are updated using this two-step approach.

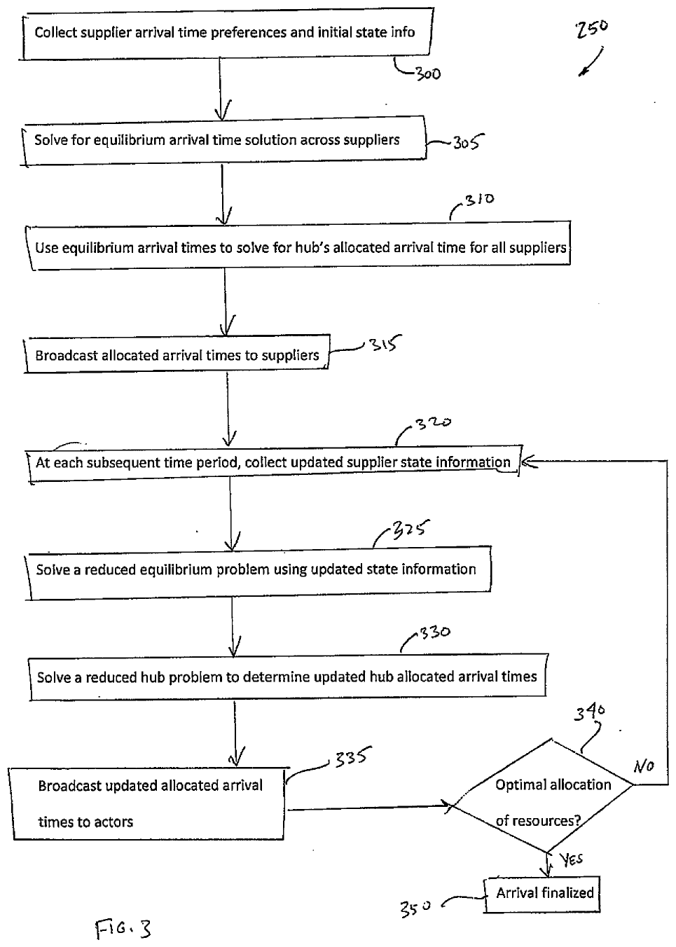

Referring to FIG. 3, in one exemplary embodiment of the computation segment 250 of the scheduler 200, a plurality of processes may be carried out. In doing so, arrival time preferences of each actor 110 (as the supplier) may be collected, along with initial state information, as indicated at block 300. The arrival time preferences may be based upon, for example, a desire of the actor 110 to unload cargo during daylight hours or to avoid inclement weather. As a further example, when the actor 110 is a cargo ship, preferences may also be based on tide information along with combinations of other factors such as ship draft, depth of shipping lanes, and the amount of fuel being carried (which may affect the ship draft).

Once the preferences of each actor 110 are collected in block 300, an equilibrium arrival time solution across all actors 110 may be solved for, as indicated at block 305, using the Nash Equilibrium values. In solving using the Nash Equilibrium, the arrivals of the actors 110 at the hub 120 are considered over overlapping time spans. Each of the considered actors 110 may have a utility function that depends upon their respective speed (proportional to their fuel cost, for example), travel time, the amount of cargo to be transferred to other actors 110, and the amount of cargo to be received from other actors 110. Such a model provides a constrained set of actor-desired arrival times.

Once the equilibrium arrival time solution across all actors 110 is solved for, as indicated at block 305, the solution may be used to solve for an allocated arrival time for each actor 110 from the perspective of the hub 120, as indicated at block 310. In solving for an allocated arrival time for each actor 110 from the perspective of the hub 120, an optimization framework may be used to optimize the arrival order of the actors 110 by taking into account the number of units/cargo that are actually transferred to the hub 120, as well as information from the actors 110 such as their preferred arrival times (from block 300) and other constraints. The optimization framework may be based on the SSLOATP. In solving in block 310, the number of units actually conveyed by the actor 110 will generally be those carried by the actor 110 for delivery (possibly for re-transport by a subsequent actor 110) and also those units destined for the actor 110 which had been previously delivered to the hub 120. The SSLOATP model may generally be combinatorially difficult to solve, but algorithms disclosed herein provide suitable solutions to the optimization problem in practice.

Once the solution is used to solve for an allocated arrival time for each actor 110 from the perspective of the hub 120, as indicated at block 310, allocated arrival times may be broadcast, as indicated at block 315, from the scheduler 200 to the actors 110.

As indicated in block 320, after the actors 110 receive their allocated arrival times, updated state information is then collected from the actors 110 at each designated time period 210.

At block 325, using the updated state information collected from the actors 110, a reduced equilibrium arrival time solution across all actors 110 is solved.

Once the reduced equilibrium arrival time solution across all actors 110 is solved for, as indicated at block 325, the solution from block 325 is then used to solve for a reduced hub problem to determine an updated allocated arrival time for each actor 110 again from the perspective of the hub 120, as indicated at block 330.

Once the updated solution is used to solve for an updated allocated arrival time for each actor 110 from the perspective of the hub 120, as indicated at block 330, updated allocated arrival times may be broadcast to the actors 110 as indicated at block 335.

Based on a result from block 335, a decision 340 may be made as to whether an allocation of an allocated arrival time is on target and the arrival can be carried out. If so, then an actor 110 will arrive, as indicated at block 350. If no arrival can be carried out, control in the computation block 230 will loop back to block 320 to collect further updated state information from the actors 110 at each designated time period 210 and new updates may be calculated.

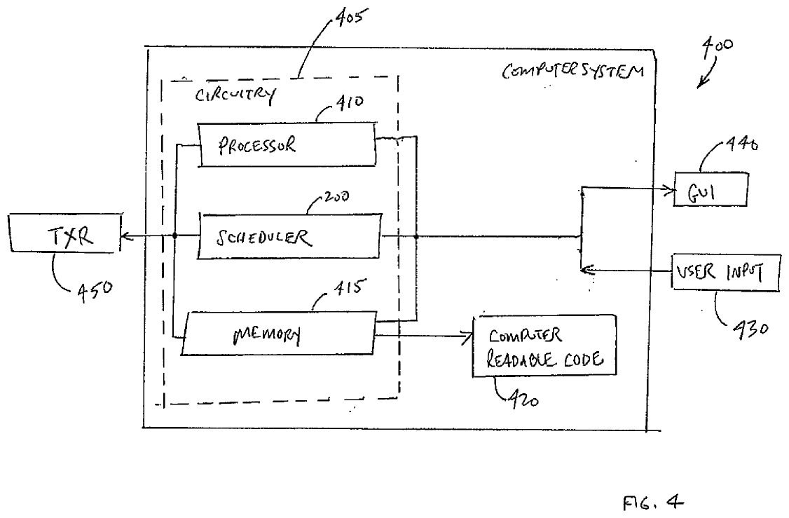

Referring to FIG. 4, the scheduler 200 may be part of a computer system 400 having circuitry 405 with one or more processors 410 and associated memories 415. The memories 415 may include computer readable code 420, which when accessed and executed by the one or more processors 410, causes the computer system 400 to perform the operations described herein, such as those described in the Figures. The scheduler 200 may be implemented in whole or part in the circuitry 405, which itself may implement the one or more memories 415 and the one or more processors 410. For instance, the scheduler 200 may be implemented in an integrated circuit or as part of a programmable logic device. User input to the computer system 400 may be received through a user input device 430, and output may be provided to the user via a display such as a graphical user interface (GUI) 440. Using the scheduler 200, a transmitter 450 may be directed to transmit an allocated arrival time to a particular actor 110 or to broadcast two or more of the allocated arrival times to two or more of the actors 110.

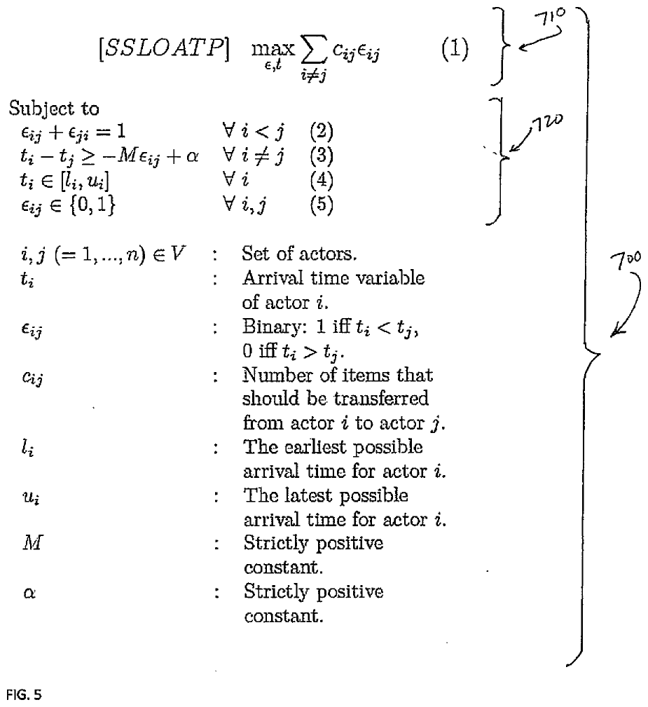

Referring now to FIG. 5, one exemplary embodiment of a hub decision making framework in which an optimization problem may be solved is shown generally at 700. The optimization problem is the Single Slot Ordering and Arrival Time Problem (the SSLOATP). In solving the problem using the framework 700, the hub operator 140 determines the arrival pattern of the actors 110, given the information received from the actors 110 at the preceding time epoch. It may be supposed that each actor 110 is served instantly and that service time has a duration a. The parameter a represents the processing time (e.g., time required to unload and load) and the waiting time. It may also be assumed that each actor 110 leaves immediately upon being served; a consequence of this is that the actor 110 abandons any cargo which may have been destined for it but whose arrival occurs after it leaves. It may also be assumed that there are n actors 110 during the time horizon and a single slot. However, the extension to multiple slots is also contemplated.

To solve the problem, the SSLOATP is given upper and lower bounds for actor arrival times and shipment costs. This may be combinatorially difficult to solve, and so an approximation algorithm 710 subject to constraints 720 is proposed as a re-optimization problem for partial solutions in order to provide suitable solutions. The proposed approximation algorithm 710 may be based on updated sequential changes to state. The parameter cᵢⱼ is denoted as the number of items to be transferred from actor i to actor j. The decision variables ϵᵢⱼ specify if the actor i arrives before actor j.

The objective as indicated in the algorithm 710 maximizes the sum of the items actually transferred. Item (2) of the constraint set 720 ensures that for every couple (i,j) of actors 110, either i comes before j or j comes before i. Item (3) of the constraint set 720 enforces that ϵᵢⱼ=1⇔tᵢ−tⱼ<0. That is, supposing that tᵢ−tⱼ<0, then Item (3) implicates then that ϵᵢⱼ=1 if M is large enough, otherwise tᵢ−tⱼ≥0. Supposing that ϵᵢⱼ=1, Item (2) indicates that ϵⱼᵢ=0, and Item (3) then indicates tⱼ−tᵢ≥α>0. The constraint set 720 also ensures that there are no cycles (i arrives before j, j arrives before k, and k arrives before i). Item (3) then implicates that tᵢ<tⱼ<tₖ<tᵢ, which is impossible. Item (4) indicates that the arrival time of each actor should lie within the feasible range.

The approximation algorithm 710 deals with two decisions simultaneously: determining an order of arrival and specifying the optimal arrival times according to that order. If only the order is restricted, however, a Linear Ordering Problem (LOP) is obtained. The LOP would be defined as: given an n×n matrix C, the LOP seeks a permutation π of the column and row indices {1, . . . , n} such that the value

$$f ( π ) = {\sum }_{i = 1}^{n} {\sum }_{j = i + 1}^{n} {c}_{π ( i ) π ( j )}$$

is maximized. This amounts to the maximizing sum of the elements in the upper triangle portion of the matrix C. In some embodiments, a weighted feedback are set (WFAS) problem may be used as an alternative to or with the LOP.

In the framework 700 solving the SSLOATP, it should be noted that any change in ordering can alter the arrival times. Motivated by this difficulty, it is proposed to decompose the approximation algorithm 710 into an LOP and a feasibility problem that can be formulated as an LP. The first step is to determine a linear order that respects the potential infeasibilities between arrivals. This amounts to solving an LOP in which some of the ϵᵢⱼ are already fixed: ϵᵢⱼ=0 whenever there is an infeasibility:

$$[ STEP 1 ] Set {ϵ}_{ij} = 0 whenever {u}_{j} \leq {l}_{i} or ( {u}_{j} > {l}_{i} \& {u}_{j} - {l}_{i} > α ) \qquad$$

After fixing a partial order, a complete order is sought:

$$\begin{matrix}[ STEP 2 ] Maximize {\sum }_{i \neq j} {c}_{ij} {ϵ}_{ij} & \\ Subject to & \\ {ϵ}_{ij} + {ϵ}_{ji} = 1 ∀ i < j & ( 2 ) \\ {ϵ}_{ij} + {ϵ}_{jk} + {ϵ}_{ki} \leq 2 ∀ i < j , i < k & ( 3 ) \\ {ϵ}_{ij} ∈ \{ 0 , 1 \} ∀ i , j & ( 4 ) \\ {ϵ}_{ij} = 0 ∀ i , j s . t . {u}_{j} \leq {l}_{i} & ( 5 )\end{matrix}$$

Solving the LOP may be done exactly for small instances, and through heuristics for larger instances. Given now an ordering from STEP 2, it can be determined if there is a combination of arrival times that respects this ordering by solving a feasibility linear program using the result of STEP 2 as the input:

[STEP3] Maximize g

Subject to:

tᵢ−tⱼ≥−Mϵᵢⱼ+g∀i≠j (3)

This feasibility problem may not yield a feasible solution (in terms of arrival times). In other words, if g* is the output of STEP 3, then there is not a guarantee the g*>α.

In the case of a multi-actor equilibrium model, the proposed framework involves the actors 110 each determining their desired arrival time, which is a function of current location and speed, as well as the items intended for delivery and pick up. Given that the availability of the slot or berth upon arrival is a constrained resource, the resulting problem among the actors can be viewed as an equilibrium problem.

More specifically, the strategy of each actor 110, as i, sᵢ, may be given by the time of arrival of the actor 110. The utility of the actor 110 as i, if the set of played strategies is s=(s₁, sᵢ, . . . , sₙ), is given in the following game:

$${s}_{i} ∈ [ {l}_{i} , {u}_{i} ] \\ {u}_{i} ( s ) = ( {\sum }_{k \neq i} {c}_{ki} {1}_{{s}_{k} < {s}_{i}} + {\sum }_{k \neq i} {c}_{ik} {1}_{{s}_{k} > {s}_{i}} ) \frac{1}{\vert k , {s}_{k} = {s}_{i} \vert} - {α}_{i} ( \frac{{d}_{i}^{2}}{{s}_{i}} + {s}_{i} ) , \qquad ( 2 )$$

where dᵢ is the distance of the actor i to the hub operator 140 and |k, sₖ=s| is the number of actors arrive at sᵢ (including actor i), and αᵢ≥0 is a constant that makes tradeoffs with regard to the transhipment utility with the travelling cost for actor i. The Nash Equilibrium points are obtained from this game.

Referring to all of the Figures, the exemplary embodiments described herein differ from other hub-and-spoke network management processes in that a sequential decision-making approach is carried out whereby both actors and facility operators determine their respective operational parameters but exchange information and update the decisions on a predetermined time schedule (for example, daily). The processes of the sequential decision-making approach as described herein are formulated in a framework with interacting models for the decisions of both the actors 110 and for hub operators 140. The overall process is expected to repeat daily with alternating model resolution and information exchange between the actors 110 and the hub operators 140 (for example, as maritime vessels/ports, trucks/trucking terminals, airplanes/airports). At each time epoch (which may be a day), the hub operator 140 solves a problem to determine its desired arrival ordering for the actors 110 over a rolling time horizon and makes use of information communicated by the actors 110 at the previous time epoch so that the actors 110 are continually directed into and out of designated slots (such as berths) in an efficient manner. In doing so, the hub operator 140 communicates which particular slot is allocated to each actor 110, and in turn the actors 110 each re-solve their own operational planning problem based on their allocated slots, taking into account any unplanned changes that may have occurred since the previous epoch and communicating any infeasibilities to the hub operator 140. The process repeats and the rolling horizon is updated accordingly.

In one example, a method comprises collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

The method may further comprise transmitting, based on the determined set of allocated arrival times at the hub for each of the one or more suppliers, an arrival time to a supplier. The method may further comprise transmitting, based on the subsequent set of allocated arrival times at the hub for each of the one or more suppliers, a subsequent arrival time to the supplier. The updated arrival time preference and state information from each of the one or more suppliers may be collected based on a predetermined time period. At least one of the equilibrium arrival time solution for each of the one or more suppliers and the subsequent equilibrium arrival time solution for each of the one or more suppliers may be determined using the Nash Equilibrium. At least one of the set of allocated arrival times at the hub for each of the one or more suppliers and the subsequent set of allocated arrival times at the hub for each of the one or more suppliers may be determined as a Single Slot Linear Ordering and Arrival Time Problem. The Single Slot Linear Ordering and Arrival Time Problem may be based on the algorithm:

$$[ SSLOATP ] {max}_{c , t} {\sum }_{i \neq j} {c}_{ij} {ϵ}_{ij}$$

Collecting the arrival time preference may further include collecting state information. Outputting, at the hub, the scheduled arrival time solution for each of the one or more suppliers may comprise displaying the scheduled arrival time solution for each of the one or more suppliers on a graphical user interface.

In another example, a computer system comprises one or more memories having computer readable code; one or more processors, where the one or more processors, in response to retrieving and executing the computer readable code, cause the computer system to perform the following: collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

The updated arrival time preference and state information from each of the one or more suppliers may be collected based on a predetermined time period. At least one of the equilibrium arrival time solution for each of the one or more suppliers and the subsequent equilibrium arrival time solution for each of the one or more suppliers may be determined using the Nash Equilibrium. At least one of the set of allocated arrival times at the hub for each of the one or more suppliers and the subsequent set of allocated arrival times at the hub for each of the one or more suppliers may be determined as a Single Slot Linear Ordering and Arrival Time Problem. The Single Slot Linear Ordering and Arrival Time Problem may be based on the algorithm:

$$[ SSLOATP ] {max}_{c , t} {\sum }_{i \neq j} {c}_{ij} {ϵ}_{ij}$$

The one or more processors, in response to retrieving and executing the computer readable code, may cause the computer system to perform the following: displaying the output scheduled arrival time solution for each of the one or more suppliers on a graphical user interface.

In another example, a computer program product comprises a computer readable storage medium having program instructions embodied therewith, the program instructions executable by a computer system to cause the computer system to perform operations comprising collecting an arrival time preference from one or more suppliers of a hub-and-spoke network; determining an equilibrium arrival time solution for each of the one or more suppliers; determining, using the equilibrium arrival time solution for each of the one or more suppliers, a set of allocated arrival times at a hub for each of the one or more suppliers; collecting an updated arrival time preference from each of the one or more suppliers; determining, using the updated arrival time preference from each of the one or more suppliers, a subsequent equilibrium arrival time solution for each of the one or more suppliers; determining, using the subsequent equilibrium arrival time solution for each of the one or more suppliers, a subsequent set of allocated arrival times at the hub for each of the one or more suppliers; scheduling, based on the subsequent set of allocated arrival times, an arrival time solution at the hub for each of the one or more suppliers; and outputting, at the hub, the scheduled arrival time solution for each of the one or more suppliers.

In the foregoing description, numerous specific details are set forth, such as particular structures, components, materials, dimensions, processing steps, and techniques, in order to provide a thorough understanding of the exemplary embodiments disclosed herein. However, it will be appreciated by one of ordinary skill of the art that the exemplary embodiments disclosed herein may be practiced without these specific details. Additionally, details of well-known structures or processing steps may have been omitted or may have not been described in order to avoid obscuring the presented embodiments. It will be understood that when an element as a layer, region, or substrate is referred to as being “on” or “over” another element, it can be directly on the other element or intervening elements may also be present. In contrast, when an element is referred to as being “directly on” or “directly” over another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The description of the present invention has been presented for purposes of illustration and description, but is not intended to be exhaustive or limiting in the form disclosed. Many modifications and variations will be apparent to those of ordinary skill in the art without departing from the scope of the invention. The embodiments were chosen and described in order to best explain the principles of the invention and the practical applications, and to enable others of ordinary skill in the art to understand the invention for various embodiments with various modifications as are suited to the particular uses contemplated.

What is claimed is:

1. A method, comprising:
collecting an arrival time preference from one or more suppliers of a hub-and-spoke network;
determining an equilibrium arrival time solution for each of the one or more suppliers;
determining, using the equilibrium arrival time solution for each of the one or more suppliers, a set of allocated arrival times at a hub for each of the one or more suppliers;
collecting an updated arrival time preference from each of the one or more suppliers;
determining, using the updated arrival time preference from each of the one or more suppliers, a subsequent equilibrium arrival time solution for each of the one or more suppliers;
determining, using the subsequent equilibrium arrival time solution for each of the one or more suppliers, a subsequent set of allocated arrival times at the hub for each of the one or more suppliers;
scheduling, based on the subsequent set of allocated arrival times, an arrival time solution at the hub for each of the one or more suppliers; and
outputting, at the hub, the scheduled arrival time solution for each of the one or more suppliers.

2. The method of claim 1, further comprising transmitting, based on the determined set of allocated arrival times at the hub for each of the one or more suppliers, an arrival time to a supplier.

3. The method of claim 2, further comprising transmitting, based on the subsequent set of allocated arrival times at the hub for each of the one or more suppliers, a subsequent arrival time to the supplier.

4. The method of claim 1, wherein the updated arrival time preference and state information from each of the one or more suppliers is collected based on a predetermined time period.

5. The method of claim 1, wherein at least one of the equilibrium arrival time solution for each of the one or more suppliers and the subsequent equilibrium arrival time solution for each of the one or more suppliers is determined using the Nash Equilibrium.

6. The method of claim 1, wherein at least one of the set of allocated arrival times at the hub for each of the one or more suppliers and the subsequent set of allocated arrival times at the hub for each of the one or more suppliers is determined as a Single Slot Linear Ordering and Arrival Time Problem.

7. The method of claim 6, wherein the Single Slot Linear Ordering and Arrival Time Problem is based on the algorithm:
$$[ SSLOATP ] {max}_{c , t} {\sum }_{i \neq j} {c}_{ij} {ϵ}_{ij}$$

8. The method of claim 1, wherein collecting the arrival time preference further includes collecting state information.

9. The method of claim 1, wherein outputting, at the hub, the scheduled arrival time solution for each of the one or more suppliers comprises displaying the scheduled arrival time solution for each of the one or more suppliers on a graphical user interface.

10. A computer system, comprising:
one or more memories having computer readable code;
one or more processors, where the one or more processors, in response to retrieving and executing the computer readable code, cause the computer system to perform the following:
collecting an arrival time preference from one or more suppliers of a hub-and-spoke network;
determining an equilibrium arrival time solution for each of the one or more suppliers;
determining, using the equilibrium arrival time solution for each of the one or more suppliers, a set of allocated arrival times at a hub for each of the one or more suppliers;
collecting an updated arrival time preference from each of the one or more suppliers;
determining, using the updated arrival time preference from each of the one or more suppliers, a subsequent equilibrium arrival time solution for each of the one or more suppliers;
determining, using the subsequent equilibrium arrival time solution for each of the one or more suppliers, a subsequent set of allocated arrival times at the hub for each of the one or more suppliers;
scheduling, based on the subsequent set of allocated arrival times, an arrival time solution at the hub for each of the one or more suppliers; and
outputting, at the hub, the scheduled arrival time solution for each of the one or more suppliers.

11. The computer system of claim 10, wherein the updated arrival time preference and state information from each of the one or more suppliers is collected based on a predetermined time period.

12. The computer system of claim 10, wherein at least one of the equilibrium arrival time solution for each of the one or more suppliers and the subsequent equilibrium arrival time solution for each of the one or more suppliers is determined using the Nash Equilibrium.

13. The computer system of claim 10, wherein at least one of the set of allocated arrival times at the hub for each of the one or more suppliers and the subsequent set of allocated arrival times at the hub for each of the one or more suppliers is determined as a Single Slot Linear Ordering and Arrival Time Problem.

14. The computer system of claim 13, wherein the Single Slot Linear Ordering and Arrival Time Problem is based on the algorithm:
$$[ SSLOATP ] {max}_{c , t} {\sum }_{i \neq j} {c}_{ij} {ϵ}_{ij}$$

15. The computer system of claim 10, wherein the one or more processors, in response to retrieving and executing the computer readable code, cause the computer system to perform the following: displaying the output scheduled arrival time solution for each of the one or more suppliers on a graphical user interface.

16. A computer program product comprising a computer readable storage medium having program instructions embodied therewith, the program instructions executable by a computer system to cause the computer system to perform operations comprising:
collecting an arrival time preference from one or more suppliers of a hub-and-spoke network;
determining an equilibrium arrival time solution for each of the one or more suppliers;
determining, using the equilibrium arrival time solution for each of the one or more suppliers, a set of allocated arrival times at a hub for each of the one or more suppliers;
collecting an updated arrival time preference from each of the one or more suppliers;
determining, using the updated arrival time preference from each of the one or more suppliers, a subsequent equilibrium arrival time solution for each of the one or more suppliers;
determining, using the subsequent equilibrium arrival time solution for each of the one or more suppliers, a subsequent set of allocated arrival times at the hub for each of the one or more suppliers;
scheduling, based on the subsequent set of allocated arrival times, an arrival time solution at the hub for each of the one or more suppliers; and
outputting, at the hub, the scheduled arrival time solution for each of the one or more suppliers.
